(19) United States
(12) Patent Application Publication
(10) Pub. No.: US 2013/0330023 A1
(43) Pub. Date: Dec. 12, 2013

(54) Reusable, Multi-Purpose Dumpster Bag

(71) Applicant: John McGeoghean, Littleton, MA (US)

(72) Inventor: John McGeoghean, Littleton, MA (US)

(21) Appl. No.: 13/912,412

(22) Filed: Jun. 7, 2013

Related U.S. Application Data
(60) Provisional application No. 61/656,825, filed on Jun. 7, 2012.

(51) Int. Cl. B65F 1/00

(52) U.S. Cl. CPC B65F 1/0006
USPC 383/12

(57) ABSTRACT

A multi-purpose, reusable dumpster bag with a large capacity consisting of an open top, a flat bottom, and four walls including reinforced strapping with four loops attached to the top sidewalls for lifting of the bag and four loops attached to the bottom sidewalls of the bag used for tipping and dumping of the contents into the collection vehicle. Whereas the top set of four loops may be used to raise and lower the bag, the bottom set of four loops intrinsically distinguish the present invention from current single use dumpster gabs and reusable dumpster bags industry-wide, as they enable, without the aid of a discharge mechanism, this reusable dumpster bag to be easily lifted and turned upside down for dumping purposes.

### CROSS-REFERENCE TO RELATED APPLICATIONS

This application is a non-provisional application which claims the benefit to Provisional Application No. 61/656,825 filed on Jun. 7, 2012.

### BACKGROUND OF THE INVENTION

1. Field of the Invention

The present invention relates generally to waste disposal. More particularly the present invention relates to a reusable dumpster bag.

2. Description of Related Art

Currently, large metal dumpsters and other fabric dumpster bags are used for disposal of construction debris, organic waste, yard waste, household debris, and junk as well as other trash and waste materials. Most dumpster bags in use are designed for single use. Others are complicated, potentially dangerous, and labor intensive, but are nevertheless designed to be reused multiple times.

Waste management service providers have historically relied upon large and unwieldy solid plastic or metal dumpsters for the collection, transportation, and eventual disposal of garbage or other waste, trash, household trash, construction debris, and other junk. These traditional dumpsters are designed and built to be reused multiple times, but the material from which they are made is not cost efficient, flexible, or collapsible for easy and convenient storage by the user when not in use.

Due to its material and size, the traditional dumpster is difficult to handle as well as cost prohibitive for individual ownership, storage, and transportation. Many recent dumpster bags currently available are made of flexible plastic or fabric, but most are typically designed for one time use. Those that are reusable require additional setup to install bracing or have been designed with mechanical dump mechanisms that are labor intensive or involve potentially hazardous bottom discharge methods that could easily open if not securely closed or they failed during pickup.

### SUMMARY OF THE INVENTION

The subject matter of this application may involve, in some cases, interrelated products, alternative solutions to a particular problem, and/or a plurality of different uses of a single system or article.

Our reusable, multi-purpose dumpster bag (RMD) design is primarily distinguished from its predecessors based on its unique structural features: reinforced corners (either with strapping material or additional stitching), continuous strapping for additional support extending down the sides and across the bottom of the bag, durable over-lock stitching on the seams of the bag, and four dumping loops attached to the bottom sidewalls. These bottom dumping loops enable the RMD to be easily turned upside down allowing the contents of the bag to dump out in to a collection vehicle (CV), thus making the bag reusable and suitable for multiple uses in the construction, disposal, and recycling industries.

The RMD invention is unique in that it combines the dump and the reusable capabilities of the traditional hard plastic or metal dumpster with the ease of transportation, convenience, safety, and cost efficient characteristics of the one time use dumpster bags currently on the market.

The present invention is made with a durable 5-6 ounce fabric (coated or uncoated) to enable multiple uses or dumps into a CV, similar to the current manner of curbside receptacles and pickup. However, it remains flexible, collapsible, and self-supporting, so as to maintain as closely as possible, an open, upright position during the filing and loading processes as well as during the dumping process.

The present invention carries with it all the benefits of those currently used, plus the additional features of safety, reusability, and transferability. Although the present invention retains basic design features of the single use waste disposal bags currently on the market, comprising an open top, flat bottom, and four walls with lifting straps for pickup and disposal, the invention's structure further incorporates additional features ensuring it is suitable for multiple uses.

Further, what clearly distinguishes the present invention from current competitors is that it includes four loops on both the top and bottom, eight in total, in order to allow the RMD to be picked up, subsequently turned upside down, and emptied into a CV, and then returned to the consumer for reuse.

The present invention matches or exceeds the capacity of its competitors, and will be made available in multiple sizes. It is made with a woven 5-8 ounce polypropylene material that may be coated or uncoated depending on the working load and desired use of the bag. The present invention is thus ultimately made more durable than single use bags, thereby ensuring the sustainability of its quality when used repeatedly. It avoids any additional set up by the user for bracing or securing a dump mechanism, thus ensuring consumer safety and ease of use.

Materials for disposal are loaded into the RMD, and the pickup service for bag removal is then initiated. Once the pickup request is received, the CV is sent to pick up and empty the RMD on site. Before the RMD can be emptied, two straps are used to connect the RMD to the CV. The bag is lifted using two stevedore straps connecting four loops on the upper sidewalls of the bag to the CV so that the bag hangs freely in an upright position when lifted by the CV. A third strap connects two of the four loops on the lower sidewalls of the RMD to the CV. Once the RMD is positioned inside or on the CV, the straps connecting the upper loops to the CV are released. Because the second strap is still connecting two of the RMD's lower loops to the CV, upon pickup, gravity turns the bag upside down, emptying the contents into the CV to be hauled away. This eliminates the need for a complicated and potentially hazardous discharge mechanism. The now empty RMD is lowered to its original location, and the remaining strap is removed. The RMD is then returned to its owner for re-use much like their current trash receptacle is emptied and returned by current curbside pickup services.

### BRIEF DESCRIPTION OF THE DRAWINGS

FIG. 1 provides a perspective view of an embodiment of the dumpster bag.

FIG. 2 provides a perspective view of another embodiment of the dumpster bag.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

The RDB consists of a variably sized rectangular, or square, open top, woven fabric receptacle designed to be convenient for its owner to use in the removal, transportation, disposal or recycling of materials such as but not limited to: solid waste, organic materials such as wood, landscape debris or manure, recyclable metal such as appliances or loose scrap iron, construction debris and demolition debris from household projects or larger construction projects, damaged belongings from storm or flooding, brick concrete or rubble, as well as any garage, basement or attic cleanout (junk) materials.

The RDB is constructed of a durable, woven polypropylene fabric and when empty, is relatively light, easy to transport, easy to store, easy to set up, and ready to use when and where the customer desires and can be filled as the customers schedule allows, eliminating a potential rental fee commonly associated with most reusable dumpsters.

The RDB is simple to use and more convenient on small renovation or cleanout projects and uses a smaller footprint compared to conventional large metal dumpsters and could be used where conventional metal dumpsters may not even fit or be permitted to stand. The RDB is not designed to replace large metal dumpsters, which are also reusable, but to give consumers another option in the reusable dumpster/dumpster bag marketplace knowing the product they choose is itself a reusable product and not a single use product.

Consumers today are very conscious of being “green” and try to reuse, reduce and recycle when possible. The RDB allows consumers to do just that. When using the RDB it allows consumers to maintain ownership of the product when they have finished using it for another use at some point in the future, or it allows them to pass the RDB to another consumer, friend or family member to use at another location and time. This process can be done multiple times without each consumer having to purchase a single use product or a mechanically complicated reusable dumpster bag. The RDB contains NO mechanical parts. It contains NO hinges, NO doors or opening panels as do other ‘reusable” products on the market. The RDB contains NO fastening devices designed to secure the contents of the product nor does it incorporate any straps, ties or latches as some of the ‘reusable’ products on the market contain in their products. The RDB is a simple and maintenance free design, and is designed to be used over and over again saving space in landfills taken by single use dumpster bags.

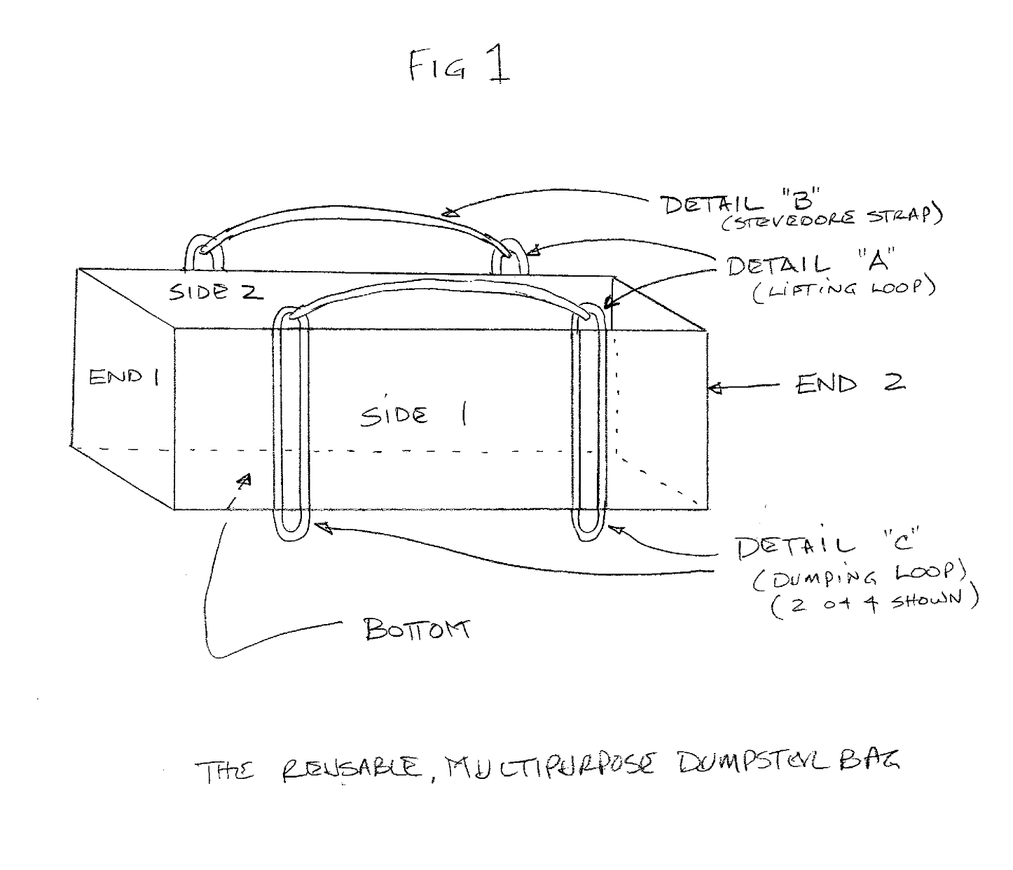

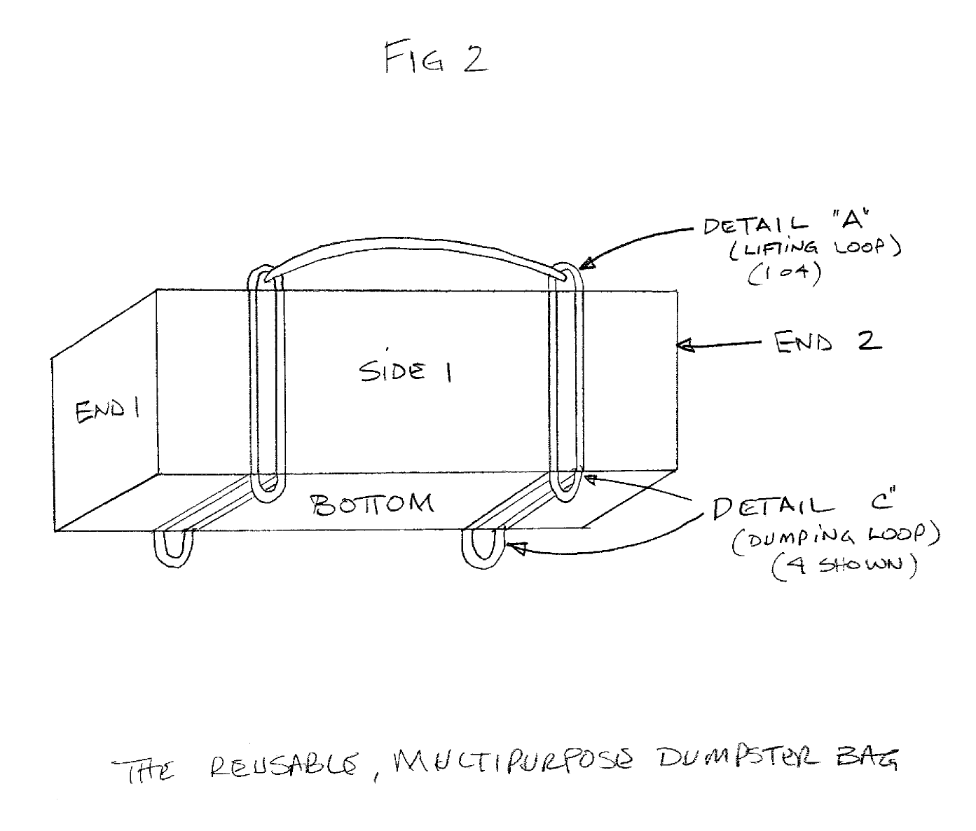

FIG. 1 represents approximately a 3 cubic yard RMD. For the 3 cubic yard RMD (FIGS. 1 and 2), the two ends have a length of ˜48 inches and a height of ˜30 inches; the two sides have a length of ˜96 inches and a height of ˜30 inches each; and the bottom panel has a length of ˜96 inches and a width of ˜48 inches. The resulting shape is a rectangular box with an open top. All lifting and dumping loops are attached as described below to the bottom part of the RMD. Stevedore straps connect the two top lifting loops along the side panels on each ˜96 inch side.

Below are dimensions for ˜3 yard size only and will vary with each RMD size.

The RMD contains TWO side panels, shown as SIDE 1 and SIDE 2 in FIG. 1 & FIG. 2, attached to the two end panels and the bottom panel by continuous reinforced stitching.

The RMD contains TWO end panels, shown as END 1 and END 2 in FIG. 1 & FIG. 2, attached to the two side panels and the bottom panel by continuous reinforced stitching.

The RMD contains ONE bottom panel shown as BOTTOM in FIG. 2, attached to the two end panels and the two side panels by continuous reinforced stitching.

The RMD contains TWO side by side pairs of 1″ to 3″ lifting and support straps made of a woven fabric material stitched vertically to the two side panels and across the bottom panel as shown in FIG. 2 making a nearly complete loop around the RDB installed to transfer and distribute the weight of the loaded material throughout the RDB.

The RMD contains FOUR 10-12″ dumping loops on the bottom of the RDB, two on each side, attached to the reinforcing straps attached to the side walls and bottom of RDB as shown in FIG. 1 & in FIG. 2.

The RMD contains FOUR 10-12″ lifting loops at the top of the RMD, two on each side, and attached to the reinforcing straps that are themselves attached to the sidewalls and bottom as shown in FIGS. 1 & 2.

The RMD contains TWO permanently attached stevedore straps connecting two lifting loops on the top of each side panel as shown in FIG. 1 & FIG. 2.

Additional Design Features:

The side panels of the RDB are approximately equal in size to one another.

The end panels of the RDB are approximately equal in size to one another.

The bottom panel of the RDB is of equal length to the side panels.

The bottom panel of the RDB is of equal width as the end panels.

The reusable RDB has an open top.

The RDB stands in a semi upright open position on its own without additional bracing or support.

The RMD has low sides and is flexible allowing the user to easily load it with materials for disposal.

The RDB is flexible and collapsible allowing one to easily store and handle it for use when desired.

The RDB is reusable allowing the owner to get multiple uses from the RDB saving the owner the cost of purchasing several RDB's to complete a project.

Operation and Use of the RDB:

Once the bag is full of material for disposal or recycling, the purchaser/owner contacts the collection company for a pickup.

The collection company arrives at the location with its COLLECTION VEHICLE (CV) (vehicles may vary depending geographic region and materials being picked up).

The operator of the CV attaches a sling or hook, already permanently attached to the CV and supplied by collection company, to the two stevedore straps on the RDB creating a single point of pickup allowing the collection and handling of the RDB to be both safe and efficient.

The operator then attaches a second strap or hook, also attached to the CV, and loosely secures this to the two dumping loops attached to the bottom of the RDB.

The RDB is then lifted off the ground and onto or into the CV. Once on board, the CV operator releases the single strap or hook attached to the stevedore straps of the RDB separating one of the two points of attachment to the CV.

The operator of the CV then proceeds to dump the RDB onto or into the CV now using the second attached strap or hook attached to the bottom dump loops attached to the RDB turning the RDB upside down allowing the contents to fall freely into or onto the CV.

At this point the operator returns the RDB in the empty condition back to the owner of the RDB if he or she so desires.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1) A reusable dumpster bag comprising:
a flexible first and second side panel;
a flexible first and second end panel, a right edge of the first end panel attached to a front edge of the first side panel, a left edge of the first end panel attached to a front edge of the second side panel, a right edge of the second end panel attached to a rear edge of the first side panel, a left edge of the second end panel attached to a rear edge of the second side panel;
a flexible bottom panel, a first end edge of the bottom panel attached to a bottom edge of the first end panel, a second end edge of the bottom panel attached to the second end panel, a right edge of the bottom panel attached to the first side panel, a left edge of the bottom panel attached to the second side panel, such that the first and second end panel, first and second side panel, and bottom panel form an open box-shaped bag;
four lifting loops, two of the four lifting loops attached to a top of the first side panel, and the other two of the four lifting loops attached to a top of the second side panel;
four dumping loops, two of the four dumping loops attached to a bottom of the box-shaped bag formed by the first and second side panel, first and second end panel, and bottom panel.

2) The reusable dumpster bag of claim 1 further comprising a first stevedore strap connecting the two of the four lifting loops attached to the first side panel, and a second stevedore strap connecting the other two of the four lifting straps attached to the second side panel.

3) The reusable dumpster bag of claim 1 further comprising a reinforcing stitching at the attachment of the first and second side panels to the first and second end panels and the bottom panel, and the attachment of the first and second end panels to the bottom panel.

4) The reusable dumpster bag of claim 1 further comprising four connector straps, each connector strap connecting one of the four lifting loops to one of the four dumping loops, each of the four connector straps being attached to one of the first or second side panels.

5) The reusable dumpster bag of claim 1 further comprising two bottom panel connector straps, each bottom panel connector strap connecting two of the four dumping loops, each of the two bottom panel connector straps being attached to the bottom panel

6) The reusable dumpster bag of claim 1 further comprising a dumping strap, the dumping strap connecting two of the dumping loops.

7) The reusable dumpster bag of claim 1 wherein the open box-shaped bag is sized to be three cubic yards.

8) The reusable dumpster bag of claim 1 wherein the first and second side panel, first and second end panel, and bottom panel are formed of woven polypropylene fabric.

9) The reusable dumpster bag of claim 1 wherein the first and second side panel, first and second end panel, and bottom panel are foldable.

10) The reusable dumpster bag of claim 1 wherein the four lifting loops and the four dumping loops are configured to hold a weight of the first and second side panel, first and second end panel, and bottom panel, along with a weight of a quantity of refuse stored within the bag.

11) A reusable dumpster bag comprising:
a flexible first and second side panel;
a flexible first and second end panel, a right edge of the first end panel attached to a front edge of the first side panel, a left edge of the first end panel attached to a front edge of the second side panel, a right edge of the second end panel attached to a rear edge of the first side panel, a left edge of the second end panel attached to a rear edge of the second side panel;
a flexible bottom panel, a first end edge of the bottom panel attached to a bottom edge of the first end panel, a second end edge of the bottom panel attached to the second end panel, a right edge of the bottom panel attached to the first side panel, a left edge of the bottom panel attached to the second side panel, such that the first and second end panel, first and second side panel, and bottom panel form an open box-shaped bag;
four lifting loops, one of the four lifting loops attached to a top corner formed by each attachment of the first and second side panels to the first and second end panels;
four dumping loops, two of the four dumping loops attached to a bottom of the box-shaped bag formed by the first and second side panel, first and second end panel, and bottom panel.

12) The reusable dumpster bag of claim 11 further comprising a first stevedore strap connecting the two of the four lifting loops along the first side panel, and a second stevedore strap connecting the other two of the four lifting straps along the second side panel.

13) The reusable dumpster bag of claim 11 further comprising further comprising a reinforcing stitching at the attachment of the first and second side panels to the first and second end panels and the bottom panel, and the attachment of the first and second end panels to the bottom panel.

14) The reusable dumpster bag of claim 11 further comprising four connector straps, each connector strap connecting one of the four lifting loops to one of the four dumping loops, each of the four connector straps being attached to one of the first or second side panels.

15) The reusable dumpster bag of claim 11 further comprising two bottom panel connector straps, each bottom panel connector strap connecting two of the four dumping loops, each of the two bottom panel connector straps being attached to the bottom panel

16) The reusable dumpster bag of claim 11 further comprising a dumping strap, the dumping strap connecting two of the dumping loops.

17) The reusable dumpster bag of claim 11 wherein the open box-shaped bag is sized to be three cubic yards.

18) The reusable dumpster bag of claim 11 wherein the first and second side panel, first and second end panel, and bottom panel are formed of woven polypropylene fabric.

19) The reusable dumpster bag of claim 11 wherein the first and second side panel, first and second end panel, and bottom panel are foldable.

20) The reusable dumpster bag of claim 11 wherein the four lifting loops and the four dumping loops are configured to hold a weight of the first and second side panel, first and second end panel, and bottom panel, along with a weight of a quantity of refuse stored within the bag.
